(19) United States
(12) Patent Application Publication
(10) Pub. No.: US 2025/0205626 A1
(43) Pub. Date: Jun. 26, 2025

(54) Air Filter Using Himalayan Salt

(71) Applicant: Ricardo Cheaz, Doral, FL (US)

(72) Inventor: Ricardo Cheaz, Doral, FL (US)

(21) Appl. No.: 18/396,382

(22) Filed: Dec. 26, 2023

(51) Int. Cl. B01D 46/00; A01N 25/34; A01N 59/08; A01P 1/00

(52) U.S. Cl. CPC B01D 46/0028; A01N 25/34; A01N 59/08; A01P 1/00; B01D 2279/65

(57) ABSTRACT

An air filter is disclosed. The air filter comprises large granule salts preferably Himalayan salt. The air filter may comprise a box for storing the large granule salts and a mesh fabric covers the box from top.

### FIELD OF INVENTION

The present invention generally relates to an air filter and more particularly to an air filter using Himalayan salt to alleviate respiratory and skin-related ailments.

### BACKGROUND OF THE INVENTION

Air Pollution has become world's single biggest environment risk, as per the report of World Health Organisation, 7 million people died in 2012 due to air pollution. As per the WHO factsheet on Household Indoor Pollutants (HAP) states that more than 3.8 million face pre-mature deaths due to the stroke ischemic heart disease, chronic obstructive pulmonary disease (COPD) and lung cancer, and all these are associated with the household air pollution. Several courses of actions are recommended to control the exposures to the contaminants, air filtration is one of them. Air filters are more effective in controlling indoor air quality. The air filters improve respiratory health issues, as air filter reduce the indoor fine particles by 60%.

The quality of an air filter is determined by several key factors, and each such factor contributes its own separate quality in the effectiveness of working of an air filter, that is capturing and reducing air borne particles, such as filter media, pleat design, frame material and design, filter size, environment impact, etc. The most important component is the filter media, that is the material from which a filter media is made. This media can be made of various materials such as fiberglass, polyester, paper, carbon, aluminum or a combination of these. The choice of filter media determines the filter's efficiency and the types of particles it can capture. The better the material the more the dirt retention capacity of the air filter.

There are various types of air filters, however, none of them are effective for environment cleaning and at the same time provide health benefits specially related to respiratory and skin-related ailments. In ancient times, Speleotherapy was a natural method used to alleviate respiratory and skin related ailments. Rooted in the therapeutic benefits observed in the salt caves, Speleotherapy involves inhaling the salty air present in these subterranean environments. However, no art is available showing the use and health benefit of Himalayan salt to alleviate respiratory and skin-related ailments. Further, bioaerosols are aerosols of biological origin, and they comprise airborne microbial contaminants such as bacteria, fungal spores, viruses, biological particulate fragments, and a range of living particles. Bioaerosols can travel through wind over long distances due to their microscopic size (0.02-100 μm), and most of them cause human respiratory diseases. Therefore, there is a need for an air filter that not only can provide filtration but also provide health benefits specially related to respiratory diseases.

### SUMMARY OF THE INVENTION

The present invention relates to air filter comprising large granule salts. In another embodiment, the air filter may comprise Himalayan salt.

The present invention provides air filter with Himalayan salt that releases microscopic salt particles into the air, providing a modern and accessible means for individuals to experience the potential respiratory benefits associated with this ancient practice. Embracing the essence of Speleotherapy, present invention, contributes to a healthier and more balanced living environment. It provides relief to people with asthma.

Present invention provides people from the comfort of their homes to use the Himalayan salt air filter as a natural healing treatment, which is a drug free, safe treatment without any side-effects, where filtration technique will remove these bioaerosols from the air and the Himalayan salt will render these microorganisms inactive by altering microbial growth parameters such osmotic pressure, water molecule movement, temperature, and pH. The main ingredient used in the air filter, i.e. salt, has been proved, through many clinical studies conducted in the eastern part of Europe, to mitigate the bad bacteria in the air. The Air Filter, with Himalayan Salt particles, inhibits the growth of the indoor environmental bacteria (maximum reduction rate: 98%). The humidity in the room must be between 40-70%, because if the air is too dry or too humid the efficacy of the filter declines.

Invention provides high concentration of sodium chloride aerosol in the salt, which has antiviral, antibacterial, and antifungal properties, helps the salt particles, purged into the air, to have an antiseptic and disinfecting impact on the mucus of the respiratory tracts and skin. Salt has properties that can help in reducing inflammation. The tiny salt particles and ions can calm the irritated respiratory systems, reducing swelling in the airways. These salt particles also promote the movement of tiny hair-like structure called cilia, which helps clear mucus and expel allergens, pathogens and even nicotine residue from the lungs. Additionally, these negatively charged salt ions can improve mood and decrease stress and anxiety.

Salt therapy through Himalayan salt air filter helps in treating and improving various respiratory problems such as cold and flu, asthma, bronchitis, sinusitis and allergies. The salt particles released through the air filter, will penetrate the epidermis and will promote the growth of good bacteria and discard the harmful bacteria, which helps in the treatment of various skin disorders like acne, dermatitis, psoriasis and eczema, as the salt has the potential to balance the pH levels and stimulates the cell regeneration process of the skin.

In an exemplary embodiment of the present invention, the air filter may comprise a box. The box may be a cuboid or cubical. In another exemplary embodiment, the box may be of another suitable shape for more surface area. In the embodiment the, the box may comprise large size salt particles. In other embodiment, the salt may be Himalayan salt. The box of the air filter may be specifically engineered to accommodate large size salt particles for long lasting performance of the air filter. In an embodiment the salt particle may be stored in a plurality of compartments.

In one embodiment of the air filter, the air filter comprises a mesh structure covering the top portion of the air filter to cover the salt. The mesh structure may be made of fabric or polyester or other suitable material.

The use of Himalayan salt provides a natural way for air purification. The Himalayan salts may be ancient ocean bed salts. In an embodiment, the salt may be of any best quality salt having best cleanliness property. The air purifier purifies air leading to a cleaner, healthier environment. The use of Himalayan salts rejuvenates the nervous system, promotes easier breathing, and improves lung conditions including bronchitis, asthma, coughs, and colds. It also provides lower blood pressure and stress levels; and improve skin health including eczema, acne, rashes, dermatitis, and aging skin.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 illustrates prospective view of the air purifier in accordance with the exemplary embodiment of the invention.

FIG. 2 illustrates another exemplary view of the prospective view of the air purifier in accordance with the embodiment of the invention.

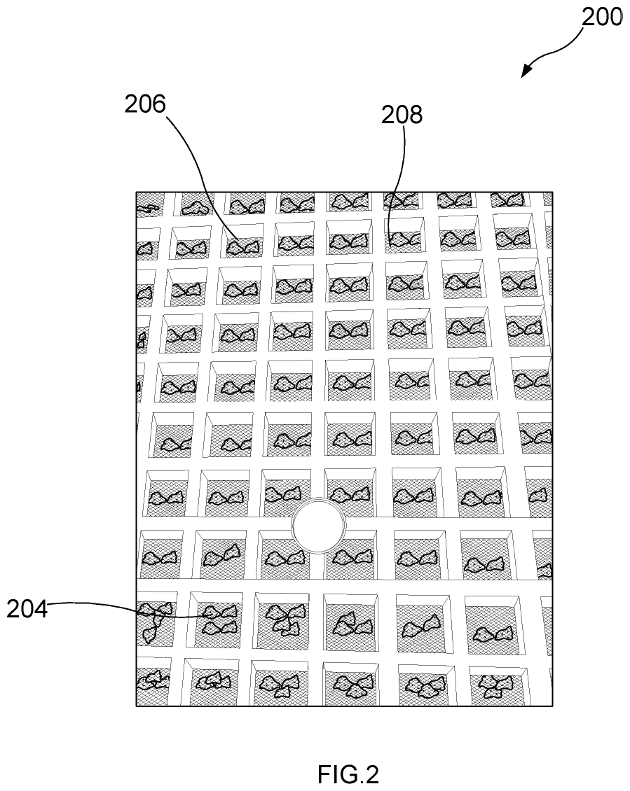

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

The present invention relates to an air filter comprising a box, Himalayan salt and a mesh fabric.

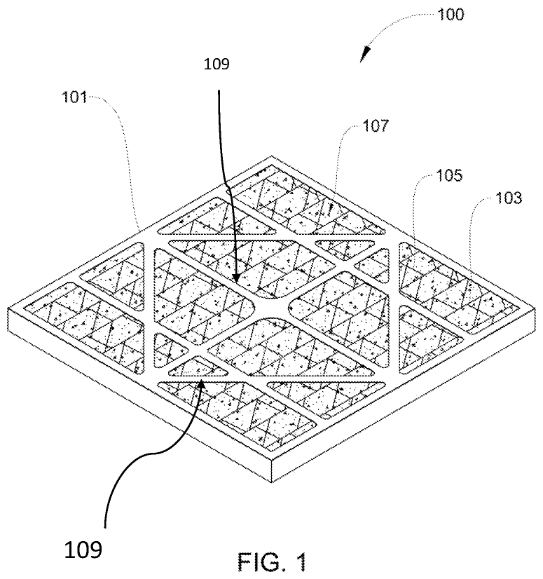

In reference to FIG. 1, the present invention provides an air filter 100 comprises a box 101 to store the salt granules or crystals. The box 101 may be of cuboid or cubical shape. In one embodiment, the box 101 may have a plurality of compartments to store salt granules or crystals 107. The compartments may be formed of various partitions 103, 105. In the embodiment, the box may have supporting elements 109 providing strength to the box. The salt used in the air filter may comprise large granule salts. In another embodiment, the air filter may comprise Himalayan salt.

In another exemplary embodiment of the present invention, the air filter 200 may comprise a box 202 for storing large granule salt 204. The box 202 (not shown) further comprises a sheet with cubical opening 206. The air filter 200 is further covered by a fabric mesh 208 form top and the salt preferably Himalayan salt. The mesh 208 provides breathability to the air filter during air filtration process. The mesh 208 covering the top portion of the air filter may be made of fabric or polyester or other suitable material.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. An air filter comprising:
a box comprising a large granule salt, wherein the large granule salt is Himalayan salt.

2. The air filter as claimed in claim 1, wherein the box is covered with fabric mesh.

3. The air filter as claimed in claim 1, wherein the box comprises supporting elements providing strength to the box.
